(19) United States
(12) Patent Application Publication
(10) Pub. No.: US 2019/0319397 A1
(43) Pub. Date: Oct. 17, 2019

(54) ELECTRIC CONNECTOR PANEL TO BE MOUNTED IN A DEVICE HOUSING

(71) Applicant: Amphenol-Tuchel Electronics GmbH, Heilbronn (DE)

(72) Inventor: Michael Carle, Heilbronn (DE)

(73) Assignee: Amphenol-Tuchel Electronics GmbH, Heilbronn (DE)

(21) Appl. No.: 16/462,295

(22) PCT Filed: Nov. 15, 2017
(86) PCT No.: PCT/EP2017/079271

§ 371 Date: May 20, 2019

(30) Foreign Application Priority Data
Nov. 21, 2016 (DE) 10 2016 122 397.2

(51) Int. Cl. H01R 13/52; H01R 13/518; H01R 13/74; H01R 13/622

(52) U.S. Cl. CPC H01R 13/5202; H01R 13/622; H01R 13/743; H01R 13/518

(57) ABSTRACT

The invention relates to an electric connector panel which is to be mounted on a wall of a device housing having an interior. Said electric connector panel comprises at least two integrated electric connectors, the housings of which are interconnected by means of a common mounting plate, and also comprises one contact member for each electric connector as well as at least one contact element per contact member.

The invention relates to a connector panel for installation in a device housing.

A wide variety of embodiments of connectors is already known from the prior art. However, if the intention is for a plurality of connectors to be installed with a precisely defined spacing or position with respect to one another, in many available solutions a complex measurement and alignment process needs to take place during mounting. In addition, separate grounding usually needs to be produced between the connectors and, if desired, the contacts of the connectors usually need to be connected to one another.

The invention is therefore based on the object of overcoming the abovementioned disadvantages and providing a simple and inexpensive solution which makes mounting quicker and easier in comparison with conventional solutions.

This object is achieved by the combination of features as claimed in patent claim 1.

In accordance with the invention, therefore, a connector panel is proposed for mounting on a device housing wall of a device housing having an interior, wherein the connector panel has at least two integrated connectors, the respective housings of said connectors being connected to one another via a common mounting plate, and each connector has in each case one contact body and at least one contact element per contact body.

An advantageous embodiment is present in this case if an apparatus for premounting the connector panel in the device housing is formed on the mounting plate, preferably in the form of latching elements on the mounting plate which latch into corresponding latch-in elements of the device housing. In this case, the premounting forms the first part of the entire mounting process, in which first the panel is inserted into the housing. The apparatus for premounting in this case fixes the panel in all directions if a corresponding mating piece is formed on the housing. In this case, however, as yet the device housing is not completely sealed off from the ingress of dust, dirt or fluids as a result of the premounting. Complete sealing is only realized by the final mounting.

It has proven to be advantageous if a mounting point, suitable for the connection of a PE conductor, is provided on the mounting plate. In this case, the mounting point is designed in such a way that the PE conductor can be released again without any destruction.

It is furthermore advantageous if the mounting plate is formed cohesively with the respective housing of the connectors. As a result, the number of required component parts is reduced and increased stability and dimensional stability of the thus integrally formed components is achieved.

In this case, it is of particular advantage if the mounting plate, the respective housings of the connectors, the mounting point and the apparatus for premounting are configured integrally as a cast metal part. By virtue of this embodiment, which represents a cohesive connection of all components involved, a high degree of stability and dimensional stability and a reduction in the component parts are achieved. In addition, all of the metallic housing components of the connector panel can thus be grounded jointly via the mounting point and are thus also brought to a common potential.

A preferred embodiment is present if a sealing surface plane of a first connector which is used for sealing off the device housing from the ingress of foreign matter through the aperture created for the connector is in the same plane as a sealing surface plane of a second connector and therefore forms a common sealing surface plane.

In this case, it is particularly advantageous if a sealing element for the at least two connectors is arranged on the common sealing surface plane thereof. As a result, both a reduction in the components and simplified mounting are achieved. By virtue of the thus enlarged sealing surface, improved sealing with respect to the ingress of dust, dirt and/or fluids into the device housing after the final mounting is also ensured. In this case, the final mounting of the connector panel corresponds to the application of a permanent force on the connector panel, wherein the force pushes or pulls the mounting plate against the sealing element and the sealing element against the device housing wall, with the result that the sealing element seals off the apertures in the device housing which are necessary for passing through the connectors of the connector panel.

It is advantageous in this case if the surface of the sealing element, in the mounted state, rests flat against the device housing wall, wherein the surface runs parallel to the common sealing surface plane, and the sealing element furthermore has a uniform thickness.

A likewise advantageous embodiment provides that a surface of the sealing element rests, in the mounted state, against the device housing wall, wherein the surface does not run parallel to the common sealing surface plane, and the sealing element therefore has different thicknesses.

It is advantageous for sealing purposes in this case if the sealing element is closed circumferentially around the connector contours, at least where the sealing element rests against the housings of the connectors, and forms a spectacle frame-like shape.

An advantageous implementation in this case envisages that the sealing element is positioned between the common mounting plate and the device housing wall in the interior of the device housing.

It is advantageous for mounting in this case if the at least two connectors form an external thread on the outer circumference of part of their respective housing which, in the mounted state, is not positioned in the interior. After the premounting, in each case one screw nut can then be applied to these external threads and the final mounting can be implemented by virtue of these screw nuts being tightened. This also realizes complete sealing-off of the housing at the apertures or openings introduced for mounting purposes.

A preferred embodiment is likewise present if an electrically conductive connection is formed between a contact element of one contact body and a contact element of a further contact body. This is particularly advantageous if the terminals of a connector of the connector panel are intended to be looped through onto another connector of the connector panel. For this purpose, all of the contact elements of a contact body then need to be electrically conductively connected to the corresponding contact elements of another contact body. This also facilitates the connection of a connector panel provided for this purpose since this can take place as early as during the production process or at least prior to installation.

A further preferred embodiment in this case envisages an adapter connector, which, in the mounted state, is positioned in the interior of the device housing, and one contact element of which is connected to the contact element of at least one connector via a second electrically conductive connection. As a result, the connection of the contact elements in the interior of the housing can be performed particularly easily since complex wiring of the individual contact elements of the contact bodies can be performed as early as prior to mounting and an electrical connection between other components in the interior of the device housing can be realized very easily later via the adapter plug.

Other advantageous developments of the invention are characterized in the dependent claims and will be illustrated in more detail below together with the description of the preferred embodiment of the invention with reference to the figures, in which:

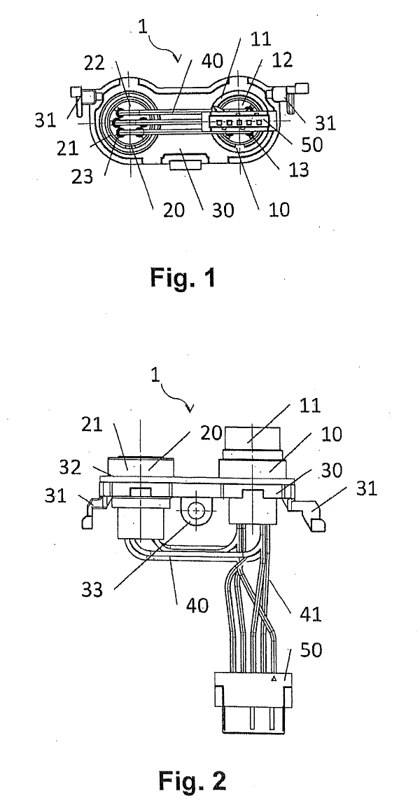

FIG. 1 shows a rear view of a connector panel;

FIG. 2 shows a plan view of a connector panel;

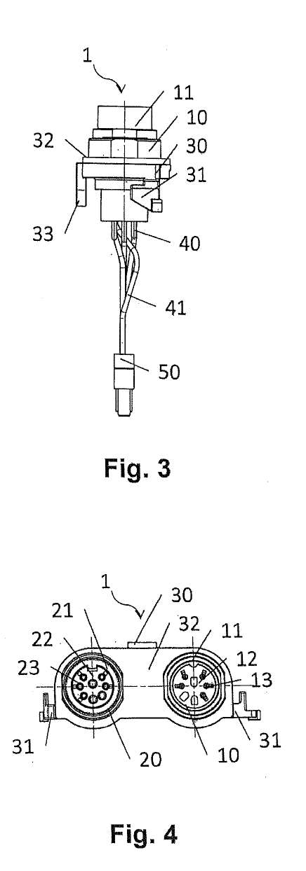

FIG. 3 shows a side view of a connector panel;

FIG. 4 shows a front view of a connector panel;

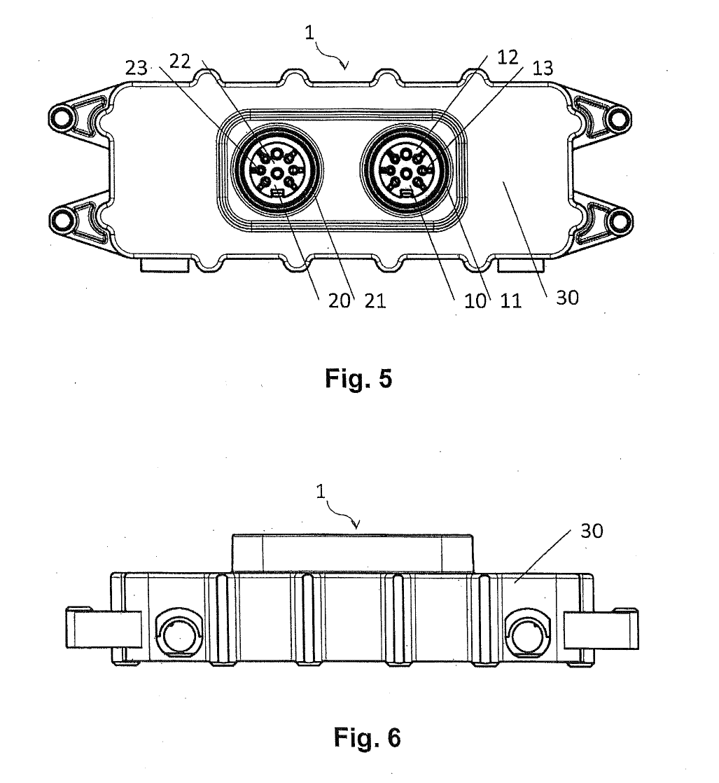

FIG. 5 shows a plan view of an alternative embodiment of a connector panel;

FIG. 6 shows a side view of an alternative embodiment of a connector panel.

The figures are schematic by way of example. Identical reference symbols in the figures indicate identical functional and/or structural features.

FIG. 1 shows a connector panel 1 in a rear view. In this case, in addition to the housings 11 and 21 of two connectors 10 and 20, their respective contact bodies 12 and 22 as well as the mounting plate 30 can be seen. A plurality of contact elements 13 and 23 are visible within the contact bodies 12 and 22, wherein, by way of example, in each case only one has been identified.

The electrically conductive connection 40 which produces a contact between in each case one contact element of a connector and another contact element of another connector, as well as the adapter connector 50 and the apparatus for premounting 31 can likewise clearly be seen in the rear view.

FIG. 2 shows a connector panel 1 in a plan view. In this case, as well as the housings 11 and 21 of two connectors 10 and 20, the mounting plate 30, the sealing element 32 and the mounting point 33 can be seen. The electrically conductive connection 40 which produces a contact between in each case one contact element of the connector 10 and another contact element of the other connector 20, the electrically conductive connection 41 which produces a contact between at least one contact element of the connector 20 and the contact element of the adapter connector 50, and the apparatus for premounting 31 can likewise also clearly be seen in the plan view.

FIG. 3 shows the side view of a connector panel 1, wherein, in addition to the connector 10, the housing 11 of said connector is shown. Also visible are the sealing element 32, the mounting plate 30, the mounting point 33, the apparatus for premounting 31 and the electrically conductive connection 40 and the electrically conductive connection 41, which produces a contact between at least one contact element of the connector 20 and the contact element of the adapter connector 50.

FIG. 4 shows the front view of the connector panel 1 in accordance with the first exemplary embodiment, showing the connectors 10 and 20 and the housings 11 and 21 thereof, contact bodies 12 and 22 and a plurality of contact elements 13, 23, of which in each case one contact element has been identified by way of example. Also visible is the sealing element 32, which is flat and runs in the form of spectacles around the housings 11 and 21, and a section of the mounting plate 30 behind this and the apparatus for premounting 31, which is in the form of arms 35 which are bent back and protrude laterally away from the mounting plate 30 and is arranged on the mounting plate 30 in each case in a region beneath a central line M, passing through the two connectors 10, 20. The arms 35 consist of arm sections 35a extending parallel to the sealing plane and of arm sections 35b running transversely thereto.

The arm sections 35a form, in the direction of the side facing the interface side of the connector panel 1, in each case one stop surface 36a, which is aligned with the rear side of the mounting plate 30.

At the ends, blocks 35c are formed on the transversely running arm sections 35b, wherein webs 35d of the arm sections 35b extend in the direction of the central line M.

The mounting plate 30 has an upper edge 37 running in a straight line and a lower edge 38, which runs diametrically opposite the central line M and forms two arcuate edge sections 38a, 38c, which are each formed directly adjacent to the position of the connectors 10, 20. The lower edge 38 runs parallel to the upper edge 37 between the two arcuate edge sections 38a, 38c.

FIG. 5 shows an alternative embodiment in a plan view, showing a mounting plate 30 and the connectors 10 and 20 and the associated housings 11 and 21, contact bodies 12 and 22 and the contact elements 13 and 23, of which in each case one has been identified by way of example.

FIG. 6 shows an alternative embodiment in a side view showing only the mounting plate 30.

The invention is not restricted in terms of its embodiment to the preferred exemplary embodiments specified above. Instead, a number of variants are conceivable which make use of the illustrated solution even in the case of embodiments which are in principle different.

### LIST OF REFERENCE SYMBOLS

1 connector panel

10 connector

11 housing

12 contact body

13 contact element

20 connector

21 housing

22 contact body

23 contact element

30 mounting plate

31 premounting

32 sealing element

33 mounting point

35 arm

35a arm section

35b arm section

35c block

35d web

36a stop surface

37 upper edge

38 lower edge

38a edge section

38c edge section

40 connection

41 connection

50 adapter connector

M central line

1. A connector panel for mounting on a device housing wall of a device housing having an interior, wherein the connector panel comprises at least two integrated connectors, respective housings of said connectors being connected to one another via a common mounting plate, in each case one contact body for each connector, and at least one contact element per contact body.

2. The connector panel as claimed in claim 1, wherein an apparatus for premounting the connector panel in or on the device housing is formed on the mounting plate in the form of arm-shaped latching elements on the mounting plate which can latch into corresponding latch-in elements of the device housing.

3. The connector panel as claimed in claim 1, wherein a mounting point for a PE conductor is formed on the mounting plate.

4. The connector panel as claimed in claim 1, wherein the mounting plate is formed cohesively with the respective housings of the connectors.

5. The connector panel as claimed in claim 4, wherein the mounting plate, the respective housings of the connectors, a mounting point and an apparatus for premounting the connector panel in or on the device housing, are configured integrally as a cast metal part.

6. The connector panel as claimed in claim 1, wherein a sealing surface plane of the first connector which is used for sealing off the device housing from the ingress of foreign matter through an aperture created for the connector is in the same plane as a sealing surface plane of the second or further connector to form a common sealing surface plane on the mounting plate.

7. The connector panel as claimed in claim 6, wherein a sealing element for the at least two connectors is arranged on the common sealing surface plane thereof.

8. The connector panel as claimed in claim 7, wherein a surface of the sealing element which is provided for sealing purposes rests, in the state in which the connector panel is mounted on a housing, against the device housing wall thereof, wherein the surface of the device housing wall runs parallel to the common sealing surface plane, and the sealing element has a uniform thickness.

9. The connector panel as claimed in claim 6, wherein a surface of the sealing element provided for sealing purposes rests, in the state in which the connector panel is mounted on a housing, against the device housing wall thereof, wherein the sealing element has different thicknesses along its surface provided for sealing purposes.

10. The connector panel as claimed in claim 7, wherein the sealing element is closed circumferentially around the connector contours and forms a spectacle frame-like shape.

11. The connector panel as claimed in claim 8, wherein the sealing element is positioned between the common mounting plate and the device housing wall in the interior of the device housing.

12. The connector panel as claimed in claim 1, wherein the at least two connectors form an external thread on the outer circumference of part of their respective housing which, in the state in which the connector panel is mounted on a housing, is not positioned in the interior of said housing.

13. The connector panel as claimed in claim 1, wherein an electrically conductive connection is formed between a contact element of one contact body and a contact element of a further contact body.

14. The connector panel as claimed in claim 1, wherein an adapter connector, which, in the mounted state, is positioned in the interior of the device housing, and at least one contact element of which is connected to the contact element of at least one of the two connectors via a second electrically conductive connection.

15. A device comprising a device housing in or on which a connector panel as claimed in claim 1, is mounted, wherein the connector panel is mounted in sealing fashion with its mounting plate via a sealing element against an inner wall of the device housing in such a way that the mounting plate is located in the interior of the housing.
